(19) United States
(12) Patent Application Publication
(10) Pub. No.: US 2003/0121003 A1
(43) Pub. Date: Jun. 26, 2003

(54) Application launcher testing framework

(75) Inventors: Kirill O. Soshalsky, Santa Clara, CA (US); Artem A. Aliev, St. Petersburg (RU); Dmitry A. Fazunenko, St. Petersburg (RU); Andrey Y. Chernyshev, St. Petersburg (RU)

Correspondence Address: MARTINE & PENILLA, LLP, 710 LAKEWAY DRIVE, SUITE 170, SUNNYVALE, CA, 94085, US

(73) Assignee: Sun Microsystems, Inc., Palo Alto, CA

(21) Appl. No.: 10/039,197

(22) Filed: Jan. 4, 2002

Related U.S. Application Data
(60) Provisional application No. 60/343,080, filed on Dec. 20, 2001.

(51) Int. Cl. G06F 15/00

(52) U.S. Cl. 715/513

(57) ABSTRACT

An invention for an application launcher testing system is provided. The system includes an HTTP server that is in communication with an application launcher, and receives a query for a test application from the application launcher. A status server is also included that is in communication with the test application. The status server receives a test status from the test application. Further, the system includes a test monitor that is in communication with the HTTP server and the status server. The test monitor receives a query status from the HTTP server and the test status from the status server.

### CROSS REFERENCE TO RELATED APPLICATIONS

This application claims the benefit of U.S. Provisional Patent Application No. ______ (Attorney Docket No. SUNMP019+), filed Dec. 20, 2001, and entitled “Application Launcher Testing Framework,” which is hereby incorporated by reference.

### BACKGROUND OF THE INVENTION

1. Field of the Invention

This invention relates generally to computer program testing and more specifically to application launcher testing frameworks.

2. Description of the Related Art

Currently, Java environments can be categorized into various Java technologies. A Java technology is defined as a Java specification and its reference implementation. Examples of Java technologies are Java 2 Standard Edition (J2SE), Java 2 Enterprise Edition (J2EE), and Mobile Information Device Profile (MIDP). As with most other types of Java software, a new Java technology should be tested to assure consistency across multiple platforms. This testing is generally performed using compatibility testing.

Compatibility testing refers to the methods used to test an implementation of a Java technology specification in order to assure consistency across multiple hardware platforms, operating systems, and other implementations of the same Java technology specification. When this assurance is accomplished by means of a formal process, application developers can then be confident that an application will run in a consistent manner across all tested implementations of the same Java technology specification. This consistent specification-based behavior is a primary function of compatibility testing.

Compatibility testing differs from traditional product testing in a number of ways. Unlike product testing, compatibility testing is not primarily concerned with robustness, performance, or ease of use. The primary purpose of Java compatibility testing is to determine whether an implementation of a technology is compliant with the specification of that technology.

Compatibility test development for a given feature relies on a complete specification and reference implementation for that feature. Compatibility testing is a means of ensuring correctness, completeness, and consistency across all implementations of a technology specification that are developed. The primary goal of compatibility testing is to provide the assurance that an application will run in a consistent manner across all tested implementations of a technology.

To determine if the implementation of a particular Java technology is compliant with the specification for the particular Java technology, technology compatibility kits (TCK) may be used. A TCK is a suite of tests, tools, and documentation that allows an implementor of a Java technology specification to determine if the implementation is compliant with the specification.

A TCK typically includes a Test Harness, defined as the applications and tools that are used for test execution and test suite management, and a TCK Test Suite, which is the composite of the actual test cases in a TCK that are executed to test an implementation. A TCK can also include documentation that includes the specific TCK usage procedures, and the compatibility testing requirements that apply to the related technology release (usually in the form of a TCK user's guide). Also, a description of the TCK appeals process can be included, as well as an audit process, which is used to better ensure the integrity of a consistent self-testing compatibility program.

However, conventional TCK Test Harnesses and test suites generally cannot provide test feedback when elements other than the API, compiler, or JVM are used in an application. For example, programs are currently available that allow a user to launch applications by clicking on a Web page link. If the application is not present on the user's computer, the program automatically downloads and caches all the necessary resources on the user's computer. The application is then ready to be relaunched anytime the user desires. Further, the program automatically finds and downloads any application updates, resulting in the most current version of the application being presented to the user.

To test such a program requires testing of the launcher used to remotely launch the application, the download protocol (such as Basic Download protocol HTTP), the descriptor file protocol, security sandbox, and other test elements. Since conventional TCK test suites only test the API, compiler, or JVM, these other elements are not tested. Consequently, conventional TCK test suites do not provide any verification of the correctness, abilities, or efficiencies of these other elements. For example, complete testing would require information on whether the test application was started correctly and in the correct environment. Further, the Hypertext Transfer Protocol (HTTP) server should feed back confirmation as to whether or not the application launcher sent correct HTTP requests.

In view of the foregoing, there is a need for systems and methods providing application launcher testing frameworks. The systems and methods should allow complete testing of the launcher frameworks, including providing test information from the launched test and the HTTP Server that provides resources to the application launcher.

### SUMMARY OF THE INVENTION

Broadly speaking, the present invention fills these needs by providing an application launcher testing framework that provides test information from the application launcher, the test application, and the HTTP server, which generates resources based on the test suite and current environment information. In one embodiment, an application launcher testing system is disclosed. The system includes an HTTP server that is in communication with an application launcher, and receives a query for a test application from the application launcher. A status server is also included that is in communication with the test application. The status server receives a test status from the test application. Further, the system includes a test monitor that is in communication with the HTTP server and the status server. The test monitor receives a query status from the HTTP server and the test status from the status server.

In another embodiment, a method is disclosed for testing an application launcher. An HTTP server, a status server, and an application launcher are launched. The application launcher queries the HTTP server for a test application, and the test application is launched using the application launcher. A test status is returned from the test application to the status server, and the test status, a query status, and a launch status are returned to a test monitor.

Another application launcher testing system is disclosed in a further embodiment of the present invention. The system includes a HTTP server that is in communication with an application launcher, wherein the HTTP server receives a query for a test application from the application launcher, and wherein the application launcher launches the test application based on a response to the query from the HTTP server. A status server that is in communication with the test application, and which receives a test status from the test application, is also included. Further, the system includes a test monitor that is in communication with the HTTP server and the status server. The test monitor receives a query status from the HTTP server, the test status from the status server, and an exit code from the application launcher, which indicates a launch status of the test application launch. The test monitor then combines the query status, the test status, and the launch status into a report. Other aspects of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1A is a diagram showing computer screen shots of a computer program started using an application launcher;

FIG. 1B is diagram showing an application launcher system;

FIG. 2 is a module diagram showing an application launcher testing framework, in accordance with an embodiment of the present invention;

FIG. 3 is a sequence diagram showing a test sequence for a test application launched via an application launcher, in accordance with an embodiment of the present invention;

FIG. 4A is a flowchart showing a method for testing a test application launched via an application launcher, in accordance with an embodiment of the present invention;

FIG. 4B is a flowchart continuing the method from FIG. 5A for testing a test application launched via an application launcher, in accordance with an embodiment of the present invention; and

FIG. 5 is a block diagram of an exemplary computer system for carrying out the processing according to the invention.

### DETAILED DESCRIPTION OF THE PREFERRED EMBODIMENTS

An invention is disclosed for an application launcher testing framework. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

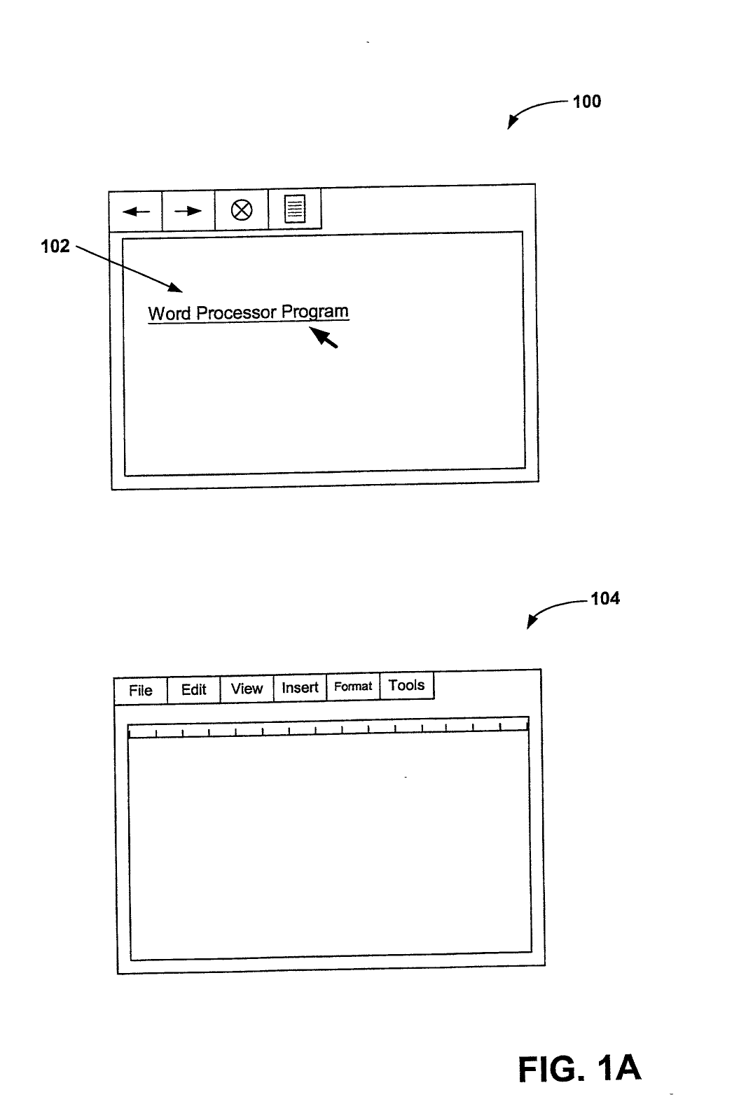

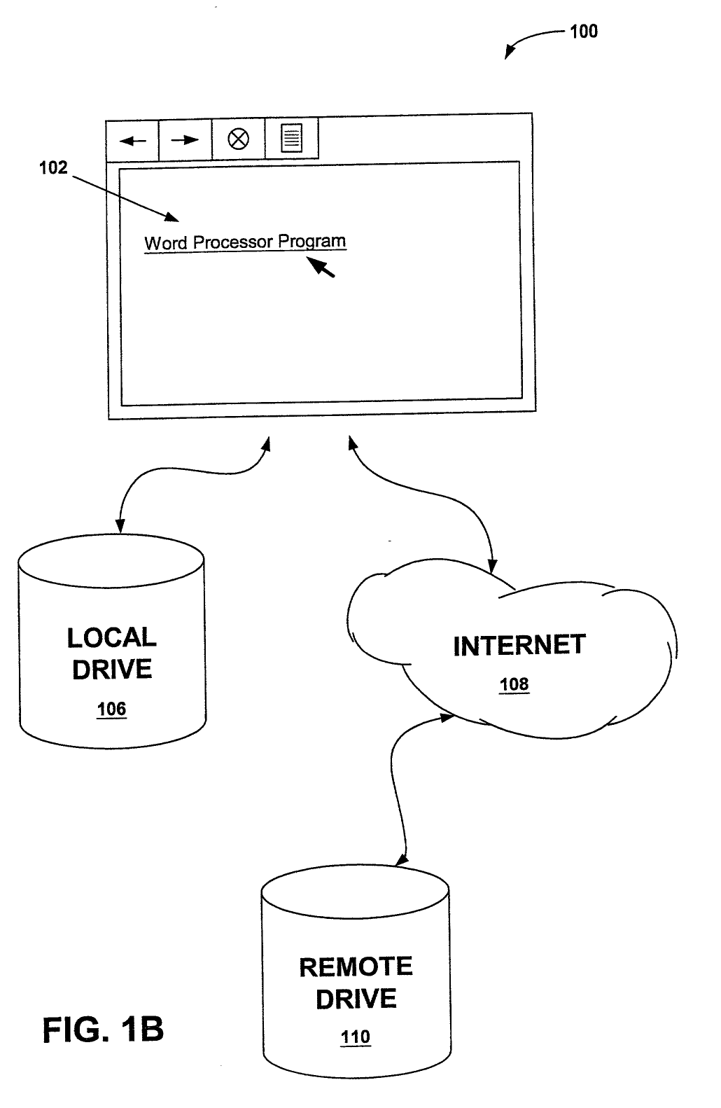

FIG. 1A is a diagram showing computer screen shots of a computer program started using an application launcher. As mentioned above, application launcher programs are currently available that allow a user to launch applications by clicking on a Web page link. Screen shot 100 shows a computer screen having a link 102 to an application program, in this example, a word processor program. Using an application launcher, the user can select the link 102 to launch the word processor program. Thereafter, the word processor program 104 is launched and the user may begin to use the program. As will explained in greater detail below, the application launcher allows the user to launch the word processor program 104 regardless of whether the program code is located locally or remotely.

FIG. 1B is diagram showing an application launcher system. In particular, FIG. 1B illustrates the computer operations that occur when a user selects the link 102 to launch an application program using the application launcher. In particular, the link 102 includes a Uniform Resource Locator (URL) to the application. For example, the link 102 includes a URL to the word processor application 104. If the application is present on the user's computer, the application launcher starts the application from the local drive 106. If the application is not present on the user's computer, the application launcher automatically downloads all necessary files from the remote drive 110 via a network, such as the Internet 108, as indicated by the URL. The application launcher then caches the files on the local drive 106 so the application is always ready to be relaunched anytime the user desires. Further, the application launcher can automatically find and download any updates so that the most current version of the application is presented to the user.

The embodiments of the present invention provide techniques to test an application launcher. As mentioned previously, to test such an application launcher requires testing the API, the download protocols, the descriptor file protocol, the security sandbox, and other elements. Thus, embodiments of the present invention provide verification of the correctness, abilities, and efficiencies of these elements. For example, embodiments of the present invention provide test information on whether the test application was started correctly and in the correct environment, and confirmation as to whether or not the application launcher sent correct HTTP requests.

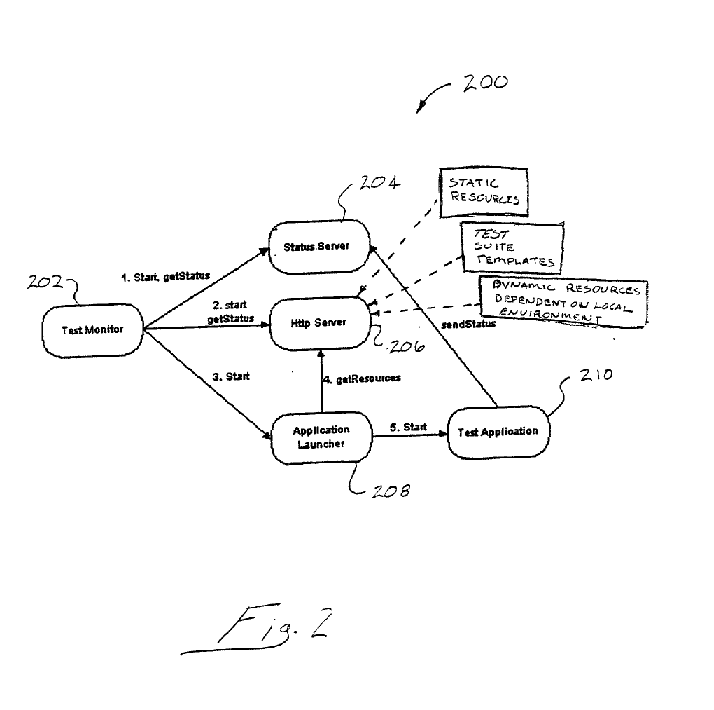

FIG. 2 is a module diagram showing an application launcher testing framework 200, in accordance with an embodiment of the present invention. The application launcher testing framework 200 includes a test monitor 202, a status server 204, an HTTP server 206, an application launcher 208, and test application 210. Although, FIG. 2 is shown with only one test application 210, it should be noted that multiple test applications 210 could be included, as desired by the user.

Broadly speaking, the test monitor 202 is a central element of the application launcher testing framework 200. As such, the test monitor 202 starts tests, collects the test results, and combines the test results. The test monitor 202 also provides a graphical user interface (GUI) for the user. The HTTP server 204 provides the resources needed by the application launcher 208, and verifies the requests made by the application launcher 208. The test application 210 is a Java application that is downloaded and started by the application launcher 208. Generally, the test application 210 checks the environment it is executing in and reports the result to the test monitor 202 via the status server 204. The status server 204 retrieves the statuses of the test application 210, and optionally, other custom parts of the test. These statuses are then provided to the test monitor 202.

Each part of the application launcher test framework 200 starts its own thread or process. Specifically, during operation, the test monitor 202 starts the status server 204 and the HTTP server 206. As mentioned above, the status server 204 retrieves the statuses of the test application 210, while the HTTP server 204 provides the resources needed by the application launcher 208 and verifies the application launcher's 208 requests. The test monitor 202 also launches the application launcher 208 using the URL of the test application 210. The test application 210 can be located remotely, for example as over a network such as the Internet, or locally, such as from the local hard drive. In either case, the URL that is provided to the application launcher 208 informs the application launcher 208 as to the location of the test application 210.

Using the URL provided by the test monitor 202, the application launcher 208 then queries the HTTP server 206 for information concerning the test application 210 and downloads the information. The application launcher 208 then analyzes the information provided by the HTTP server 206, and based on the downloaded information, downloads and executes the test application 210.

During execution, the test application 210 performs tests and checks the environment in which it is executing. In addition, the test application 210 connects to the status server 204. Using the connection, the test application 210 can obtain the status on the tests and return the status of the test to the status server 204, which provides the tests status to the test monitor 202.

In addition, the HTTP server 206 also returns a status to the test monitor 202. The embodiments of the present invention test the HTTP download protocols in addition to the API tested by the test application 210. Specifically, when the application launcher 208 queries the HTTP server 206, the HTTP server 206 provides the query information to the test monitor 202. In this manner, the embodiments of the present invention can determine the correctness and efficiency of the application launcher 210 queries to the HTTP server 206. For example, the test monitor 202 can determine whether or not the application launcher 210 sent the correct query to the HTTP server 206 using the correct fields. Thus, the HTTP server 206 analyzes the queries and sends the status back to the test monitor 202.

Hence, the test monitor 202 receives test statuses from both the status server 204 and the HTTP server 206. In addition, the application launcher 208 provides an application launch status to the test monitor 202. The test monitor 202 then creates a multi-status report based on the statuses received from the status server 204, the HTTP server 206, and the application launcher 208.

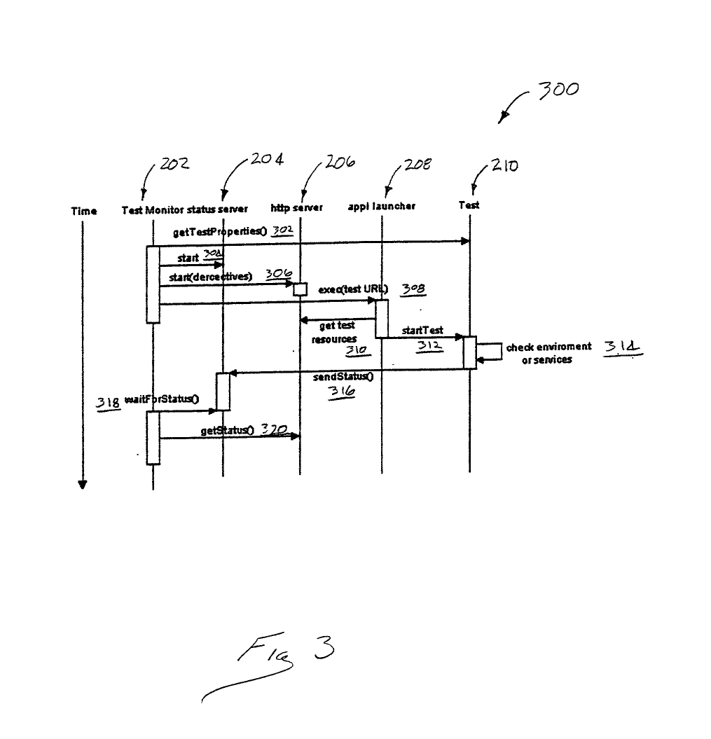

FIG. 3 is a sequence diagram showing a test sequence 300 for a test application launched via an application launcher, in accordance with an embodiment of the present invention. The test sequence 300 illustrates the module interaction for runing a test application launched via an application launcher. Broadly speaking, each module starts its own thread or process.

Specifically, the test monitor 202 can get selected test properties of the test application, in operation 302. These test properties can include the test application class name and resources, such as the OS type, hardware architecture type, and locale information. In addition, test properties can include the test application jar file name and the test application descriptor file name. In operation 304, the test monitor 202 starts the status server 204, and in operation 306, the test monitor 202 starts the HTTP server 206. In some embodiments, the test monitor provides start directives to the HTTP server 206 in operation 306.

The test monitor 202 then executes the application launcher 208 using the URL of the test application 210, in operation 308. In response, the application launcher 208 obtains the test resources and test executable from the HTTP server 206, in operation 310, and, in operation 312, starts the test application using the test executable. The test application then checks the environment or services in operation 314. In this operation, the test application may test an API and other environment or services local to the test as will be apparent to those skilled in the art.

The test application 210 then provides the test status to the status server 204, in operation 316. In operation 318, the test monitor 202 receives the status from the status server 204, and in operation 320, gets the status from the HTTP server 206. The test monitor 202 can then processes the statuses from the application launcher, the status server, and the HTTP server. Thus, the test monitor receives test statuses from both the status server and the HTTP server. In addition, the application launcher provides an application launch status to the test monitor. The test monitor can then create a multi-status report based on the statuses received from the status server, the HTTP server, and the application launcher.

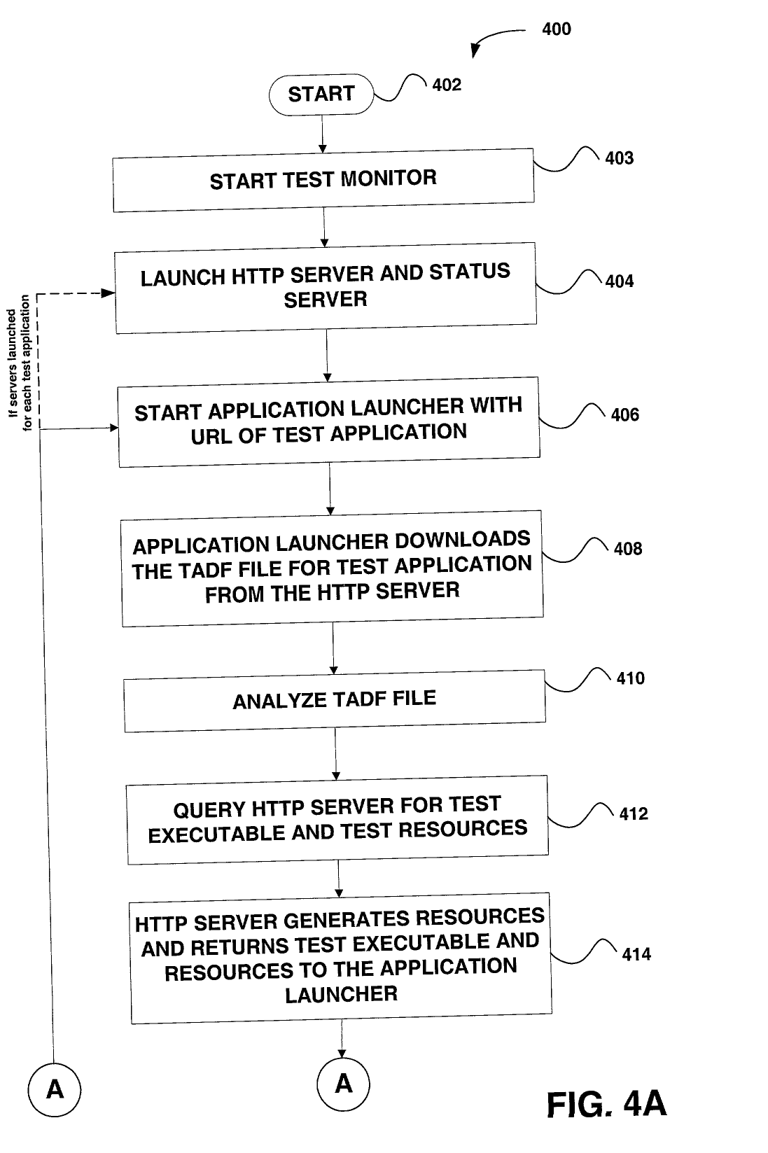

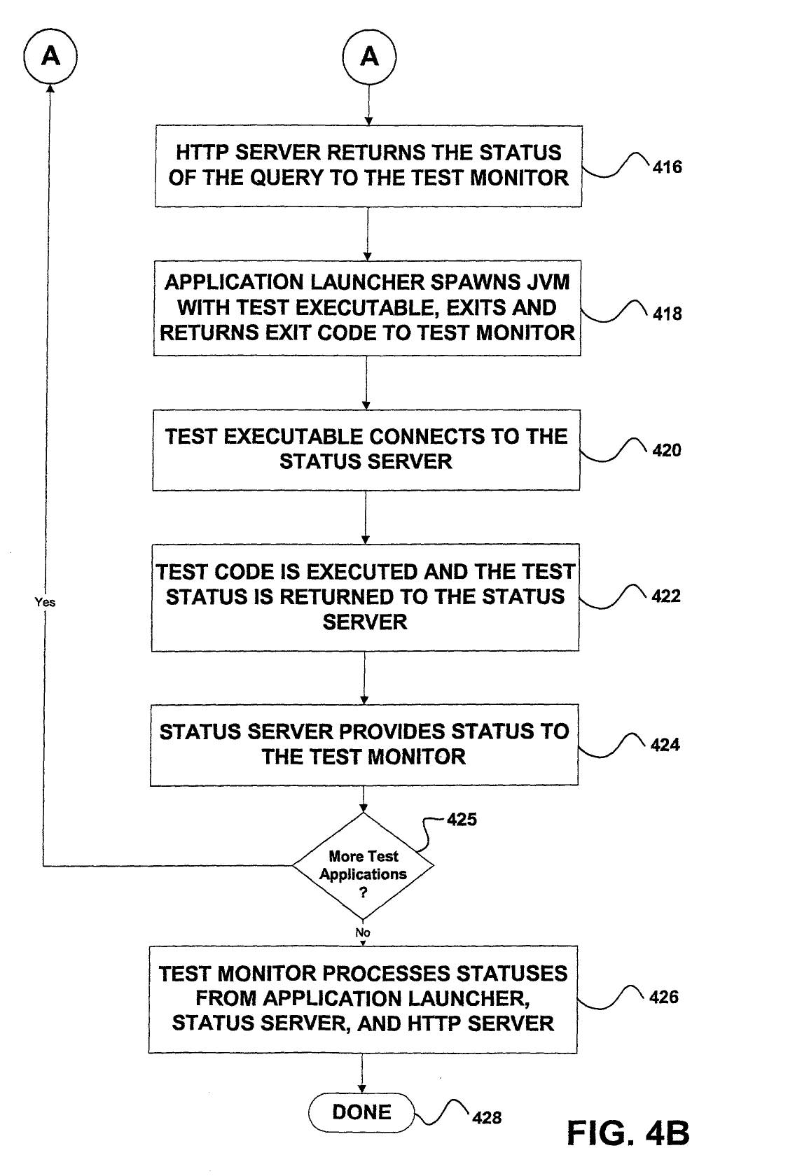

FIGS. 4A and 4B illustrate a flowchart showing a method 400 for testing a test application launched via an application launcher, in accordance with an embodiment of the present invention. In an initial operation 402, preprocess operations are performed. Preprocess operations include generating a test application, provisioning the application launcher testing framework, and other preprocess operations that will be apparent to those skilled in the art.

The test monitor is started, in operation 403, and the HTTP server and the status server are launched is operation 404. Generally, the test monitor starts both the HTTP server and the status server. However, either or both the HTTP server and the status server can be launched separately. For example, when the test application is stored remotely from the test monitor, the HTTP server can be started separately, while the test monitor launches the status server directly. Moving from operation 404 to operation 406, the application launcher is started using the URL of the test application. The URL points to the descriptor file for the test application, which is located on the HTTP server.

In operation 408, the application launcher downloads the test application descriptor file (TADF) for the test application from the HTTP server. Then, in operation 410, the application launcher analyzes the TADF. The application launcher uses the TADF to launch applications from resources hosted on a network. A TADF typically includes a description of the test application resources. For example, XML may be used for this purpose. The test application launcher determines the format of the TADF. One exemplary TADF is a Java network launcher protocol (JNLP) file.

Moving to operation 412, the application launcher queries the HTTP server for information concerning the test file. Specifically, the application launcher queries the HTTP server for the test application executable. In addition, the application launcher may query the HTTP server for other resources needed by the test application. Resources can include other executable files, information needed by the application launched, and other class files needed by the test application to properly perform the test operations. Since these resources themselves may be located remotely, the resources may include other TADFs to facilitate remote execution.

In addition, the information resources can be dynamic and may depend on the local environment in which the launched test application is executed. For example, in order to communicate with the status server, the test application may require the host name and the port number on which the status server is executing. The host port information generally is known only at the moment when the application is launched. As a result, the host port information generally cannot be hard coded. Due to the dynamic nature of the information resources, the HTTP server can generate this information dynamically and fill the descriptor file template with this information. In one embodiment, the test application descriptor files are stored as templates and are turned into valid files by the HTTP server. The HTTP server adapts, or finalizes, the raw test applications based on the dynamic information resources and then passed to the application launcher as a response to the query.

Once the HTTP server returns the test executable and the requested resources, the method 400 proceeds to the next operation and moves to A of FIG. 4B. At operation 416, the HTTP server returns the status of the query to the test monitor. The test monitor provides a query rules file to the HTTP server. The query rules file defines how the application launcher should query the HTTP server for a particular test application. Upon receiving the queries from the application launcher, the HTTP server compares those queries to the query rules file. The results of this comparison form the status of the application launcher query, which is returned to the test monitor. In this manner, the correctness of the queries made by the application launcher can be determined. Further, the test monitor may provide directives to the HTTP server via the query rules file. In this case, the responses from the HTTP server to the queries made by the application launcher are constructed to according to the directives the test monitor provides for a particular test application.

The application launcher spawns a separate JVM with the downloaded test executable, in operation 418. At this point, the application launcher has the test executable, and thus is able to launch the test application with a separate JVM. The application launcher then exits and returns an exit code to the test monitor. The exit code indicates whether or not the test application and the JVM were launched successfully. In some embodiments, the application launcher can also verify that the test application was launched with the correct version of the JVM. In this case, specific versions of JVMs may be required and tested using the embodiments of the present invention.

At this point, the test application is executing and connects to the status server, in operation 420. In particular, the test application opens a socket to the status server to facilitate communication of the test results. The test code of the test application is then executed and the test status is returned to the status server, in operation 422. The test application performs a series of tests, including the API tests. The results of these tests are returned to the status server.

In operation 424, the status server provides the status to the test monitor. In this manner, the test results of the test application can be obtained and analyzed even though the application launcher has previously exited. In operation 425, a decision is made as to whether addition test applications remain to be processed. If addition test applications remain to be processed, the method 400 branches to another start application launcher operation 406. Otherwise, the test monitor processes the received statuses, in operation 426. It should be noted that some embodiments of the present invention allow a separate server to be launched for each test application. In this embodiment, the method 400 branches to another launch HTTP server and status server operation 404 if addition test applications remain to be processed.

The test monitor then processes the statuses from the application launcher, the status server, and the HTTP server, in operation 426. Thus, the test monitor receives test statuses from both the status server and the HTTP server. In addition, the application launcher provides an application launch status to the test monitor. The test monitor then creates a multi-status report based on the statuses received from the status server, the HTTP server, and the application launcher.

Post process operations are then performed in operation 428. Post process operations include analysis of the multi-status report and other post process operations that will be apparent to those skilled in the art. In this manner, the multi-status report can be analyzed to determine the status of the entire application launcher test operation, including launching status, query status, and API test status.

Embodiments of the present invention may employ various computer-implemented operations involving data stored in computer systems to drive computer software, including application programs, operating system programs, peripheral device drivers, etc. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations. An exemplary structure for the invention is described below.

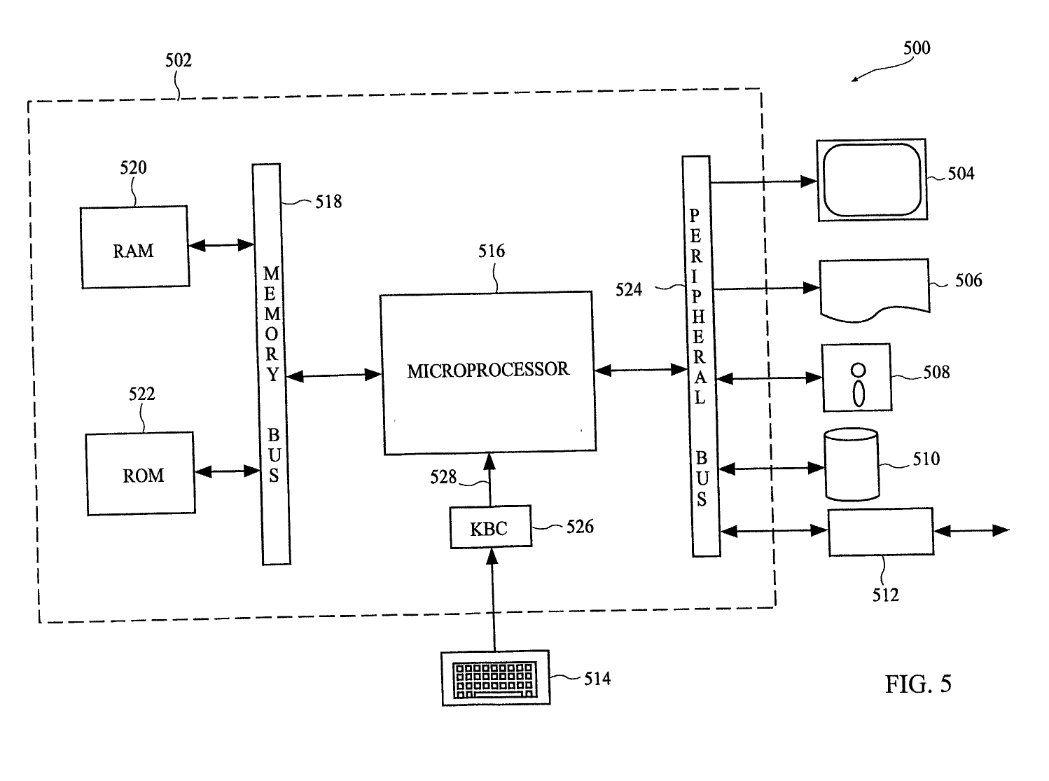

FIG. 5 is a block diagram of an exemplary computer system 500 for carrying out the processing according to the invention. The computer system 500 includes a digital computer 502, a display screen (or monitor) 504, a printer 506, a floppy disk drive 508, a hard disk drive 510, a network interface 512, and a keyboard 514. The digital computer 502 includes a microprocessor 516, a memory bus 518, random access memory (RAM) 520, read only memory (ROM) 522, a peripheral bus 524, and a keyboard controller (KBC) 526. The digital computer 502 can be a personal computer (such as an IBM compatible personal computer, a Macintosh computer or Macintosh compatible computer), a workstation computer (such as a Sun Microsystems or Hewlett-Packard workstation), or some other type of computer.

The microprocessor 516 is a general purpose digital processor, which controls the operation of the computer system 500. The microprocessor 516 can be a single-chip processor or can be implemented with multiple components. Using instructions retrieved from memory, the microprocessor 516 controls the reception and manipulation of input data and the output and display of data on output devices. According to the invention, a particular function of microprocessor 516 is to run the test monitor, which controls the application test launcher testing framework. The status server, application launcher and HTTP server can also be executed using the microprocessor 516. In some aspects, the test application and HTTP server can be initially located and on a system controlled by a separate microprocessor.

The memory bus 518 is used by the microprocessor 516 to access the RAM 520 and the ROM 522. The RAM 520 is used by the microprocessor 516 as a general storage area and as scratch-pad memory, and can also be used to store input data and processed data. The ROM 522 can be used to store instructions or program code followed by the microprocessor 516 as well as other data.

The peripheral bus 524 is used to access the input, output, and storage devices used by the digital computer 502. In the described embodiment, these devices include the display screen 504, the printer device 506, the floppy disk drive 508, the hard disk drive 510, and the network interface 512. The keyboard controller 526 is used to receive input from keyboard 514 and send decoded symbols for each pressed key to microprocessor 516 over bus 528.

The display screen 504 is an output device that displays images of data provided by the microprocessor 516 via the peripheral bus 524 or provided by other components in the computer system 500. The printer device 506, when operating as a printer, provides an image on a sheet of paper or a similar surface. Other output devices such as a plotter, typesetter, etc. can be used in place of, or in addition to, the printer device 506.

The floppy disk drive 508 and the hard disk drive 510 can be used to store various types of data. The floppy disk drive 508 facilitates transporting such data to other computer systems, and hard disk drive 510 permits fast access to large amounts of stored data.

The microprocessor 516 together with an operating system operate to execute computer code and produce and use data. The computer code and data may reside on the RAM 520, the ROM 522, or the hard disk drive 510. The computer code and data could also reside on a removable program medium and loaded or installed onto the computer system 500 when needed. Removable program media include, for example, CD-ROM, PC-CARD, floppy disk and magnetic tape.

The network interface 512 is used to send and receive data over a network connected to other computer systems. An interface card or similar device and appropriate software implemented by the microprocessor 516 can be used to connect the computer system 500 to an existing network and transfer data according to standard protocols.

The keyboard 514 is used by a user to input commands and other instructions to the computer system 500. Other types of user input devices can also be used in conjunction with the present invention. For example, pointing devices such as a computer mouse, a track ball, a stylus, or a tablet can be used to manipulate a pointer on a screen of a general-purpose computer.

The invention can also be embodied as computer readable code on a computer readable medium. The computer readable medium is any data storage device that can store data, which can be thereafter, be read by a computer system. Examples of the computer readable medium include read-only memory (ROM), random-access memory (RAM), CD-ROMs, magnetic tape, and optical data storage devices. The computer readable medium can also be distributed over a network that couples computer systems so that the computer readable code is stored and executed in a distributed fashion.

Furthermore, the same or similar methods and apparatuses described above for programming a hardware device can also be used for performing other particular maintenance operations on the hardware device. For example, operations such as erasing a ROM, reading a ROM, or performing a checksum on a ROM can be performed. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. An application launcher testing system, comprising:
a Hypertext Transfer Protocol (HTTP) server in communication with an application launcher, wherein the HTTP server receives a query for a test application from the application launcher;
a status server in communication with the test application, the status server receiving a test status from the test application; and
a test monitor in communication with the HTTP server and the status server, wherein the test monitor receives a query status from the HTTP server, and wherein the test monitor receives the test status from the status server.

2. A system as recited in claim 1, wherein the application launcher launches the test application based on a response to the query from the HTTP server.

3. A system as recited in claim 2, wherein the application launcher exits after launching the test application.

4. A system as recited in claim 3, wherein the test monitor receives an exit code from the application launcher, the exit code indicating a launch status of the test application launch.

5. A system as recited in claim 4, wherein the test monitor combines the query status, the test status, and the launch status into a report.

6. A system as recited in claim 1, wherein the query status indicates the status of the query received from the application launcher.

7. A system as recited in claim 1, wherein the test monitor starts the status server and the application launcher.

8. A system as recited in claim 1, wherein the test monitor starts the HTTP server.

9. A method for testing an application launcher, comprising the operations of:
launching a Hypertext Transfer Protocol (HTTP) server, a status server and an application launcher, wherein application launcher queries the HTTP server for a test application;
launching the test application using the application launcher;
returning a test status from the test application to the status server; and
returning the test status, a query status, and a launch status to a test monitor.

10. A method as recited in claim 9, further comprising the operation of combining the test status, the query status, and the launch status into a report using the test monitor.

11. A method as recited in claim 9, wherein the query status indicates a status of a query received from the application launcher.

12. A method as recited in claim 9, wherein the test status indicates a status of tests performed by the test application.

13. A method as recited in claim 9, wherein the launch status indicates a status of the application launch operation.

14. A method as recited in claim 9, wherein the application launcher uses a uniform resource locator (URL) to launch the test application.

15. A method as recited in claim 9, wherein the application launcher exits after launching the test application.

16. A method as recited in claim 15, wherein the application launcher returns an exit code upon exiting, the exit code providing the launch status.

17. An application launcher testing system, comprising:
a Hypertext Transfer Protocol (HTTP) server in communication with an application launcher, wherein the HTTP server receives a query for a test application from the application launcher, and wherein the application launcher launches the test application based on a response to the query from the HTTP server;
a status server in communication with the test application, the status server receiving a test status from the test application; and
a test monitor in communication with the HTTP server and the status server, wherein the test monitor receives a query status from the HTTP server, the test status from the status server, and an exit code from the application launcher, the exit code indicating a launch status of the test application launch, and wherein the test monitor combines the query status, the test status, and the launch status into a report.

18. A system as recited in claim 17, wherein the query status indicates the status of the query received from the application launcher.

19. A system as recited in claim 17, wherein the test monitor starts the status server and the application launcher.

20. A system as recited in claim 17, wherein the test monitor starts the HTTP server.
